(19) United States
(12) Patent Application Publication
(10) Pub. No.: US 2012/0290638 A1
(43) Pub. Date: Nov. 15, 2012

(54) PHYSICIAN REGIONAL ACCESS NETWORKING AGENT

(76) Inventors: Dhiraj Narula, Las Vegas, NV (US); Saurabh Tara, Henderson, NV (US)

(21) Appl. No.: 13/107,761

(22) Filed: May 13, 2011

(51) Int. Cl. G06F 15/16

(52) U.S. Cl. 709/203

(57) ABSTRACT

A medical communication system provides efficient messaging and communications services with physicians. The medical communication system permits physicians to define contact preferences so that they may receive messages in an efficient way based on various criteria, such as urgency, type, and time of a message. The medical communication system provides status for each of its physicians so that requestors that wish to contact the physicians can immediately know if a physician is available and the best way to reach the physician at a particular time and for a particular circumstance. The medical communication system protects to the privacy of physician's personal contact information and provides tracking of communications for the purpose of patient records. In addition, the medical communication system may be configured to meet various regulatory requirements, including HIPAA regulations.

### BACKGROUND OF THE INVENTION

1. Field of the Invention

The invention relates generally to communications systems, and in particular to a communications system for physicians and other medical professionals that provides efficient messaging for medical related communications to and from these professionals.

2. Related Art

The practice of medicine is evolving rapidly, and as the population ages, as science advances and new treatments become available, there is an increased demand for services. At the same time, we are now approaching the limits of society's ability to pay for these services, and provide service levels which meet patient expectations.

Other industries have been able to resolve some of these issues by increasing productivity, but medicine has been slow to deviate from existing practices. A number of innovations have occurred in delivery processes in other industries, resulting in a better customer experience at a lower cost while increasing productivity.

In order to adjust the cost-curve, different solutions have been proposed, some of which will probably achieve the opposite of their stated goal. The one area most people agree on, however, is that increased productivity of health care personnel, the most expensive part of a health care system, is an important component of reducing the cost of care.

Given the demographics of the population and the physician workforce, it is inevitable that physicians will be called on to see more patients and this can be done without limiting quality only by making their processes more efficient. The same is true for hospitals and for nurses.

For example, a newer model of efficient patient care is an exclusive hospitalist model where some insurance companies give exclusive contracts so that when a patient arrives at the hospital, the physician taking care of him/her is not their usual physician but a hospitalist whose function is to speed up the process of diagnosis, including obtaining the relevant specialty consults, necessary imaging tests, rapidly establish the plan of care, initiate treatment and discharge as soon as stabilized, for follow-up in the office with their regular physician. These exclusive contracts may also apply to specialty services. The goal is to achieve the same results in a shorter hospital stay, which patients like and is cost effective.

Though these care models improve efficiency while providing care to patients, they are most effective when communication between nurses and physicians, between hospitalists and specialists, and between hospitalists and the outpatient physicians and their staff is efficient. Traditional and other care models would also benefit from such communications efficiency.

From the discussion that follows, it will become apparent that the present invention addresses the deficiencies associated with the prior art while providing numerous additional advantages and benefits not contemplated or possible with prior art constructions.

### SUMMARY OF THE INVENTION

A medical communication system for providing efficient communication of medical information between physicians, other medical professionals, patients, and others is disclosed herein. The medical communication system enhances the flow of information to and from physicians and may provide tracking and/or recording services, such as for the purpose of keeping accurate and timely medical records. As will be set out further below, the medical communication system is highly beneficial to physicians who may be needed urgently at times, and not urgently needed at other times and who are often sought after for medical advice through a volume of calls, messages, pages and the like. It is noted that dentists, nurses, psychologists, physician assistants, nurses, nurse practitioners, emergency medical technicians and other medical professionals may utilize the medical communication system herein. As such, the term physician as used in this specification and the claims that follow should be interpreted to mean any of these individuals or any medical personnel.

The medical communication system may have various configurations. For example, in one embodiment a medical communication system for communicating with one or more physicians may comprise one or more servers comprising one or more communications devices. The servers may be configured to present one or more physicians to a requestor through a first client device, and receive a contact request from a requestor through at least one of the communications devices. It is noted that the physicians may be presented in an order based on a status of the physicians. Such physician status may comprise an indicator of whether or not the physician is available for communication.

The contact request will typically include a physician identifier that identifies a selected physician from the physicians presented. The contact request may include a delay time and, if so, the servers may delay selection of the rule and delay contact with the selected physician according to the delay time.

A status of the selected physician and one or more contact preferences of the selected physician may be retrieved from one or more memory devices accessible to the servers using the physician identifier. The contact preferences may define one or more rules for contacting the selected physician through one or more communications devices. Each of the rules may define a contact number and a criteria that must be met before the contact number may be used to initiate communication with a physician.

The servers may select at least one of the rules based on at least a status of the selected physician. The selected physician may be contacted by initiating communication with at least one of the communication devices according to the at least one rule that was selected.

The servers may be configured to receive one or more status changes from the physicians via one or more client devices, and to update the status of the physicians with the status updates. In addition, the servers may receive a work schedule from the physicians, and to update the status of the physicians based on the work schedule. It is noted that the servers may be configured to receive the location of the physicians via one or more client devices carried by the physicians, and to select the at least one rule based on the location of the physicians.

In another exemplary embodiment, the medical communication system may comprise one or more servers configured to receive status information (indicating the availability of the physicians to respond to a contact request) from one or more physicians and store the status information in one or more memory devices, and present the physicians along with their status information to a requestor at a first client device.

It is noted that only physicians with status information indicating a current availability to respond to the contact request may be presented at the first client device. In addition or alternatively, the servers may be configured to receive one or more criteria for presenting the physicians at the first client device, and to not present one or more physicians not meeting the criteria at the first client device.

Similar to above, the servers may receive a contact request comprising a physician identifier identifying a selected physician from the physicians presented from a requestor, and retrieve one or more contact preferences of the selected physician from the memory devices using the physician identifier. The contact request may include an urgency indicator configured to identify the urgency of the contact request to the servers. The contact preferences may define one or more rules for contacting the selected physician through one or more communications devices.

The servers may then execute at least one of the rules to contact the selected physician by initiating communication with a communication device according to these rule(s). Communication with the communication device may be initiated by calling the selected physician and subsequently connecting the requestor to the call.

It is contemplated that executing a first of the rules may cause the servers to initiate communication with a first communication device, while executing a second of the rules causes the servers to initiate communication with a second communication device. The first and second communication device may be distinct. For example, the first communication device may be a pager and the second communication device may be a phone.

Various methods for efficient communication are disclosed herein as well. For instance, various methods for communicating with one or more physicians using a medical communication system is disclosed. Such a method may comprise sending at least identifying information for one or more physicians to a client device for display at the client device, and receiving a contact request comprising a physician identifier identifying a selected physician from the physicians from a requestor.

One or more contact preferences of the selected physician may be retrieved from one or more memory devices using the physician identifier. The contact preferences may define one or more rules for contacting the selected physician through one or more communications devices. The contact preferences may be received from a client device of the selected physician.

At least one of the rules may be selected based on at least a status of the selected physician. The status may indicate the availability of the selected physician to respond to the contact request. It is noted that a location of the selected physician may be received by the medical communication system, and the at least one rule may be selected based on the status of the selected physician and the location of the selected physician. An urgency indicator may be received along with the contact request as well, and the at least one rule may then be selected based on the status of the selected physician and the urgency of the contact request as identified by the urgency indicator.

Communication with at least one of the communication devices may then be initiated according to the at least one rule selected from the rules. It is noted that a delay time may be received from the requestor, and if so, initiating communication with at least one of the communications devices may be delayed according to the delay time.

It is contemplated that one or more substitute physician identifiers may be received from a physician. The substitute physician identifiers may identify one or more substitute physicians with which communication may be initiated. This allows substitute physicians to be contacted if the selected physician is not available. It is noted that a variety of personnel may be identified as a substitute for the physician for communication, such as physician assistants, nurses, nurse practitioners, receptionists, and other medical personnel.

Other systems, methods, features and advantages of the invention will be or to will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is a block diagram illustrating an exemplary medical communication system in an environment of use.

FIG. 1B is a block diagram of illustrating an exemplary mobile device.

FIG. 2 is a flow diagram illustrating operation of an exemplary medical communication system.

FIG. 3 is a block diagram illustrating communications capabilities of an exemplary medical communication system.

FIG. 4 is a flow diagram illustrating setup of physician information at an exemplary medical communication system.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Unfortunately, there are many barriers limiting the speed of communication in medicine. Physicians are busy, often tied up with other patients, in surgery or in meetings. They may share coverage at hospitals with their partners for a few hours, for a particular day, on a regular or irregular schedule. They may be on vacation. For certain functions they may prefer that an assistant be contacted instead of themselves.

For this reason most physicians offer an office number. They have a staff member answer the phone and contact the physician or covering physician based on rules they have set up. After hours an answering service performs this function. A caller calls the physician number, gets transferred to an answering service, waits for an operator who takes the message, transcribes it to a pager and the caller awaits a callback, with no idea of how soon to expect a response. Either the caller has to call back if an answer is not received or the answering service may call back to check if an answer has been received and page the physician again.

Some physicians have developed workarounds to this problem. For instance, they may provide their cell phone number for patients to call directly, sometimes for an annual concierge fee (which is typically costly). Or they may provide their cell phone number to other physicians or to selected hospital departments. This has a disadvantage in that the number can get passed on to those who the physician may not wish to receive a call from. Also messages remain pending when the physician is in surgery, so the calling person has no feedback on whether the voice message was ever received. If the physician is on vacation, and still gets the call, the quality of vacation time is compromised and additional calls are needed to route the message to the covering physician. Some physicians have the answering service take the call and then call their cell phone, a tortuous workaround to protect the cell phone number.

Others use SMS text messaging to communicate with other physicians. Though this provides a reliable asynchronous method of communication, it has a particular disadvantage in that transmission of patient identifiers using a public network without encryption is a violation of HIPAA, the Health Insurance Portability and Accountability Act, rules on patient privacy. Hospitals will generally not allow their nurses to use their own cell phones to communicate with physicians in this fashion for this reason.

For hospitals, documentation of contact with physicians is an important part of the medical record. Unfortunately, with traditional processes, the nurse simply writes a note in the record stating the time of contact and the instructions thereof. This process can lead to errors and a he-said, she-said discussion after a sentinel event, which can limit the finding of an investigation and limit potential system improvements. Also, with current processes, there is no way to measure or track the speed and efficiency of response and how that might affect quality of care.

The medical communications system herein is configured to greatly improve the field of medical communications. In one or more embodiments, the medical communications system herein is directed to improving communications to and from physicians. As will be discussed further below, the medical communications system may leverage the near ubiquity of smart phone use by physicians. To illustrate, the medical communications system, may provide a constantly updated database of to physicians in the regional network and their preferences on how they would like to be communicated with. Location sensing technology (such as GPS, cell phone triangulation, and/or location lookups based on IP address) may be used to identify physician location and instantly update communication preferences based on prior rules set by the physician.

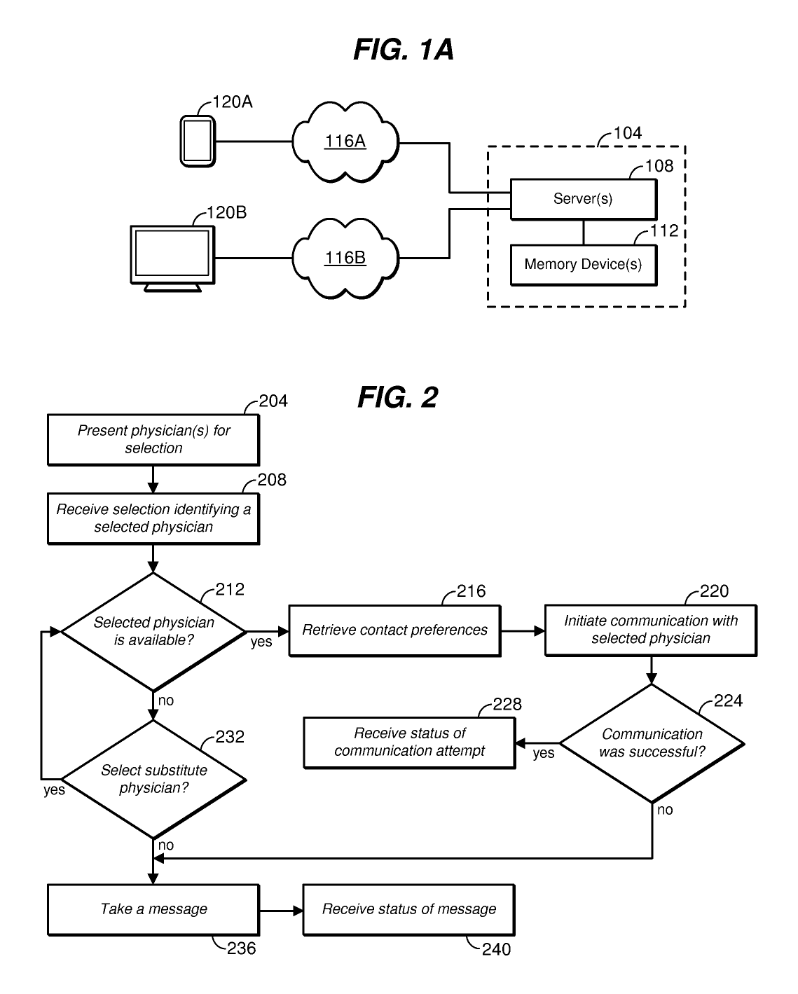

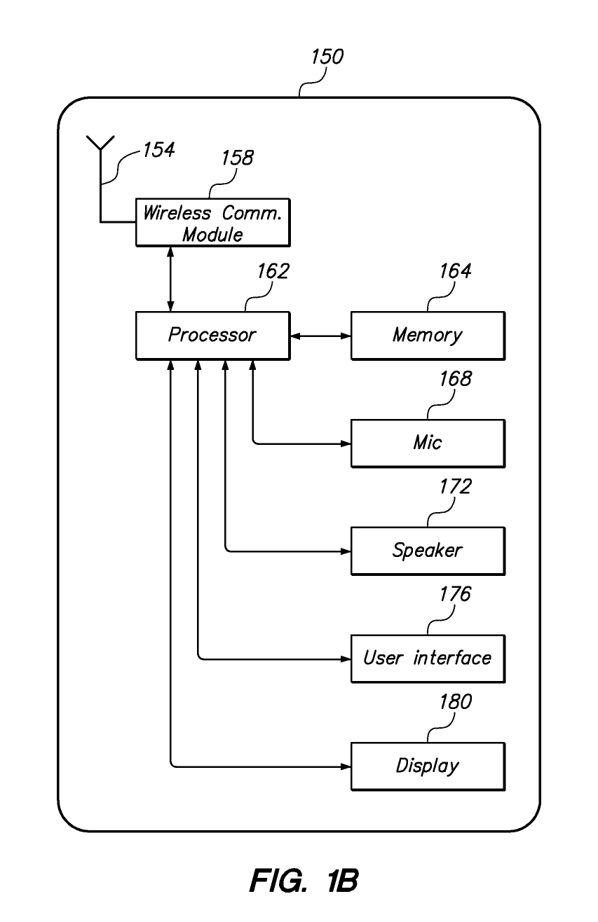

The medical communications system will now be described with regard to FIG. 1A. FIG. 1A is a block diagram illustrating an exemplary medical communication system 104 and components thereof. As can be seen, the medical communication system may comprise one or more servers 108. The servers 108 may comprise one or more processors, memory devices 112, and communication devices (such as network interfaces). In one or more embodiments, the servers 108 (such as via their processors and other components) may execute machine readable code stored on a machine readable medium, such as a physical memory device 112, to provide the functionality of the medical communication system as disclosed herein.

As can be seen, a memory device 112 may be a data storage device that may be external to the one or more servers 108. For example, a memory device 112 may be a remotely or network accessible storage device. A memory device 112 may also or alternatively be internal to the one or more servers 108. For example, a local storage device such as a hard drive may be internal to the one or more servers 108. The one or more memory devices 112 may also be various types of data storage to devices. For example, a memory device 112 may be RAM, ROM, magnetic storage, optical storage, and/or flash storage in some embodiments. Other data storage technologies now known or later developed could also be memory devices 112.

Though illustrated as encompassing a server 108 and a memory device 112, it is noted that the medical communication system 104 may encompass various other hardware. For example, the medical communication system 104 could include various client devices 120,124 or other computing devices used to interact with the system. In addition, the medical communication system 104 may have components in geographically remote locations. For example, one or more servers 108 may be at different locations to service local populations and/or to improve redundancy, reliability, and speed/quality of service.

As can be seen, the medical communication system 104 may communicate with client devices 120 in various ways. In FIG. 1, the medical communication system 104 is shown communicating via various communication links. The communications links may transmit data through various networks to allow the medical communication system 104 to communicate with client devices in many different ways. For example, as shown in FIG. 1A, the medical communication system 104 is shown communicating via a cellular data network 116A, such as to one or more mobile client devices 120A, and via the internet 116B, such as to one or more desktop, laptop, or other client devices 120B. It is noted that communication of data is not limited to these examples and may occur through various communication links to a wide variety of client devices. For example, a laptop could communicate with the medical communication system 104 through a cellular data network 116A as well as the internet 116B, or via various other communication networks.

One or more client devices 120 (as described briefly above) may communicate with the medical communication system 104. In general, this communication will allow users to interact or use the medical communication system 104. The communication between client devices 120 and the medical communication system 104 may transfer messages, status information, graphical user interface (GUI) elements, or other data when the medical communication system 104 is in use, as will be discussed further below.

The client devices 120 may be portable and non-portable computing devices capable of allowing user interaction with the medical communication system 104. For instance, a client device 120 may be one having one or more input devices to accept user information or input, and one or more output devices to present information or data to the user. For example, in one embodiment, the client device 120 may have various buttons for input and one or more screens, displays, speakers or the like for output.

The client devices 120 may comprise one or more processors and memory devices. Like the servers 108 described above, the client devices 120 may execute machine readable code to provide the functionality disclosed herein. In one or more embodiments, the client devices 120 may download or retrieve at least some of the machine readable code from an external or remote storage device. For example, machine readable code could be downloaded to the client devices 120 from the one or more servers 108 and/or memory devices 112. For example, the machine readable code could comprise one or more web pages, or be an application request by and/or transmitted to the client devices 120. In one embodiment all or some of the communication between the client devices and the servers is encrypted.

FIG. 1B illustrates a block diagram of an exemplary client device. This is but one possible configuration and as such other client device configurations are possible. The client device 150 may comprise a smart phone, tablet, personal computer, laptop, pad type computing device, or any other client device capable of functioning as described herein.

As shown in FIG. 1B, the client device 150 includes an antenna 154 configured to send and receive wireless signals over a wireless network. The wireless signal may comprise computer network wireless signal, cellular data signals, or any other type of wireless transmissions. Although shown with an antenna it is contemplated that a wired connection (not shown) may exist.

The antenna 154 connects to a wireless communication device 158 which may comprise an analog front end in communication with an analog or digital baseband processing system. The wireless communication device 158 performs and oversees the wireless communication via the antenna. A processor 162 connects to the wireless communication module 164 and is configured to interface with the various components of the client device 150. The processor 162 is capable of executing machine readable code, for example software code, which is stored on a memory 164 or received from the wireless communication module 158. Any type of special purpose or general purpose processor may be utilized.

Also part of the client device 150 is a display 180 configured to present visual information to the user. Any type or size display 180 may be utilized. A user interface 176 is also present and capable of receiving user input. The user interface 176 may comprise buttons, keys, touch elements, dials, wheels, scroll balls or may be configured as part of the display 180, such as in the case of a touch screen.

A microphone 168 and speaker 172 also connect to the processor 162 as shown, which provide audio information to the user and capture audio information from the environment of operation and from the user. Any type microphone 168 having the capability described herein and speaker 324 may be utilized.

Aspects of the operation of the medical communication device will now be described with regard to FIG. 2. FIG. 2 is a flow diagram generally illustrating communication with one or more physicians. As can be seen, at a step 204, one or more physicians may be presented to a requestor. A requestor may be a user of the medical communication system that wishes to contact a physician. The requestor may be a medical professional or a patient for example, or any other party.

The list or other arrangement of physicians may be presented via a client device, such as on a screen of the client device and retrieved from a remote database, such as memory devices 112. The presentation may facilitate fast lookup of physicians based on various criteria. For example, physicians may be found by names, hospitals, geographic service areas, specialties, pictures, insurance accepted, descriptions and other characteristics. Physicians' schedules (which may be updated through the medical communication system) may also be presented. It is noted that this information may be presented as part of the presentation of physicians or may be hidden until a physician is selected or highlighted.

The physicians may be searchable in one or more embodiments. The requestor may browse, search, or review the list of physicians. Once a desired physician is found, the requestor may select that physician to contact. For example, the requestor may click on the physician to select the physician.

The medical communication system may take into account the physician's current location in some embodiments and/or the requestor's location in some embodiments. For example, a physician may be searchable based on their current location. This is highly advantageous in emergency or urgent situations, since the closest physician capable of treating a patient may be found and contacted quickly. In one embodiment, the requestor may be presented a listing of physicians based on their distance from the requestor's location. It is noted that the requestor may also or alternatively specify various locations. In this manner, the medical communication system may determine a physician's distance from a location other than the requestors and may be selected for communication based on that criterion. For example, if a physician is needed at a clinic or hospital other than the requestor's this may be useful.

It is noted that various techniques may be used to determine a requestor's (or a physician's location). For example, GPS, cell phone triangulation, and IP address based location lookup could be used. In addition, a table or database of telephone numbers mapped to their respective physical locations may be used. For example, an outgoing number from a hospital, clinic, or other landline may be associated with its physical location. The location of calls or other messages from that number could then be determined based on caller id and the mapping between these numbers and physical locations.

At a step 208, the requestor's selection may be received. For example, a server may receive contact request information including an identifier from a client device. The identifier may be data which identify the physicians that have been selected. In some embodiments, multiple physicians may be selected. It is noted that the medical communication system may respond to a selection or “highlighting” of particular physicians by providing further information about the physician or about the physician. For example, contact information, practice information, schedules, languages spoke, or other information could be presented for a selected physician. It is contemplated that some or all this information could also be presented as part of the initial presentation of the physicians at step 204.

The contact request information may also include information regarding the contact request. For example, the location and/or identity of the requestor may be included. The urgency or type of issue (i.e., reason for contact) may also be provided. For example, urgency may be indicated by a numerical or other identifier where higher indicate increased urgency and lower values indicate decreased urgency, or vice versa. The urgency may be defined as a range of values from low or no urgency to high or maximum urgency.

The time of the request could also be included in the contact request. This information may be used to determine if a physician is available for such contact/communication, and also may be used to determine how to contact the physician according to the physician's preferences as will be discussed below.

At a decision step 212, it may be determined if the physician is available for receiving communications. There may be various rules or criteria that the medical communication system utilizes to determine the availability of a physician. A physician may be deemed available if his or her schedule indicates the physician is working or on call. A physician may have an associated status in some embodiments. The status may indicate whether the physician is working or on call for example. The status could also be other indicators. For example, the status may indicate that a physician is in surgery, on vacation, in a coverage arrangement or the like.

It is noted that the physician's status may be updated automatically by the medical communication system in some situations. For example, the physician may input his or her work schedule into the medical communication, such as via a client device in communication with the system's server(s). The medical communication system may then automatically indicate the physician's availability or unavailability based on a comparison between the current time and the work times specified in the physician's schedule. It is contemplated that the physician's schedule may be retrieved and viewed by various users of the medical communication system at various times. This is advantageous in that it leverages the up to date scheduling information captured by the medical communication system and allows it to be provided to various users (including physicians themselves) on client and other devices. Various rules established by the physician may control who may view the schedule and what aspects of the schedule are displayed.

In addition or alternatively, the medical communication system may receive status updates from physicians, such as via a client device belonging to or used by the physician. For example, a physician may update his or her status via a smart phone, PDA, laptop, or other computing device. Since these devices are portable, the physician may update his or her status from virtually anywhere. The physician could also send a message to the medical communication system to update status in other ways. For example, status updates could be sent by text message or through a call in number to the medical communication system. The status update may be a text string identifying the physician's current task in some embodiments. For example, the status update may be a sentence or other text, such as “In a meeting for the next 45 minutes” or just “In a meeting”. Other data such as identification of covering or substitution physicians/personnel may be provided in a status update. In addition, a physician may provide a schedule in a status update.

The current location of a physician may also be taken into account as part of the determination of decision step 212. This allows the physician's status to be automatically set based on his or her current location. For example, a physician that is at a particular hospital (or nearby) may be available at least to requestors at the same hospital. If a physician is too far away from where he or she is needed, the physician may be deemed unavailable. It is noted that the rules regarding availability based on the physician's current location may take into account the reason for contacting the physician. For example, if the physician is needed to by physically present (e.g., for surgery) then his or her availability may be based (entirely or partially) on his or her current location. This is especially so where the physician urgently needs to be physically present (e.g., for emergencies). If the physician is needed for a routine consultation, then his or her current location may have little or no effect on his or her availability as far as the medical communication system is concerned.

A variety of rules may be defined to identify particular locations or areas where a physician's status may be automatically set to available or unavailable. For instance, a hospital may be “geofenced” such as by defining an area including at least a portion of the hospital within which the status of physician's may be automatically set to some value. For example, if a physician is in the geofence around a hospital his or her status may be set to “Here Now” or available (at least to requestors at or near this hospital. Since physician specialties may be stored in the medical communication system, it would be possible to search for physicians having particular specialties within the hospital and rapidly contact such physicians. It is contemplated that the client device used by a physician may activate or deactivate particular features or functionality based on its location. For example, different features may be available on the client device depending on whether or not a physician is within or outside a geofence. The geofencing and automated status updates discussed above can be applied to multiple physicians or groups of physicians. As set forth herein one or more rules may control the geofence and status updates according to physician or system preferences.

The physician's location may be determined in various ways. For example, the physician may check-in with the medical communication system and provide his or her location in that manner. Alternatively or in addition, a mobile client device, such as a smart phone could detect the physician's location and report it to the medical communication system.

It is contemplated that the determination of a physician's availability may occur earlier in the processes in some embodiments. For example, the presentation of physicians at step 204 may involve determining which physicians are available. In this manner, only available physicians may be presented or may be presented before or more prominently than unavailable physicians. Alternatively, a physician's availability or unavailability may be presented during the presentation at step 204. A requestor may be permitted to input various criteria for determining availability of a physician, such as if the physical presence of a physician is required, as discussed above.

At the decision step 212, if the selected physician is available, one or more contact preferences may be retrieved for that physician. In general, the contact preferences define how and/or when a physician is to be reached. In one or more embodiments, a physician may input his or her own contact preferences into the medical communication system. These may be stored on a memory device for later retrieval.

For example, a physician may define one or more ways that the physician may be contacted synchronously or asynchronously. Synchronous communication may be two-way communication in real time. For example, a telephone call or videoconference. Asynchronous communication may be two-way communication as well but may be in less than real time. For example, asynchronous communication may be a text message, voicemail, fax or email where a response may come at a later time rather than immediately or nearly immediately.

The physician may provide cell phone numbers, landlines, fax numbers, pager numbers or other contact information that may be used to initiate asynchronous or synchronous communication. For example, a physician may specify that he or she be paged with a call back number for synchronous communication. As another example, a physician may provide a telephone number for synchronous communication. The physician may associate with each item of contact information (e.g., each phone number), when or how it may be used. For example, the physician may specify that a cell phone number may be used for emergencies or for particular requestors, while other requestors may only use a pager number, text message, or faxes to reach the physician. The physician may also specify that some requestors are routed to an assistant or office staff. The contact preferences may also specify one or more forwarding rules. For example, at particular periods of time, the physician may wish to forward calls or pages to particular numbers to other devices/numbers.

At a step 220, contact with the physician may be initiated based on the contact preferences. For example, if based on the nature of the contact request and the contact preferences, it is determined that the physician specified that he or she should be paged with a callback number, then the physician may be so paged with a callback number at step 220. If the contact preferences indicate the physician should be called, then a call may be placed by the medical communication system at step 220. It is contemplated that the medical communication system may function as an intermediary in one or more embodiments. For example, the medical communication system may call the physician and connect that call to the requestor. The same may occur for the other ways of communication specified by the physician. In this manner, the physician's telephone numbers and other contact information may be kept private.

In functioning as an intermediary, the medical communication system may mask/block or alter a caller id to preserve the privacy of a physician's telephone number. For example, in one embodiment, the caller id may be blocked. In another embodiment an alternate number may be presented as the caller id. In another embodiment, the medical communication system may forward calls placed to an alternate number to the physician's phone such as by maintaining a mapping database or table associating alternate numbers with physician phone numbers. In this manner, the physician's personal phone may be reached through an alternate number without releasing the physician's actual phone number. In another embodiment, in step 220, the communication system may relay instructions to call a number to the requestor's mobile device and block the display and/or later retrieval of the called number on the mobile device in order to keep the called physician's personal phone number private.

At a decision step 224, it may be determined if the physician was successfully contacted. For example, if a communications error occurred (e.g., no cell service), the contact may be deemed unsuccessful. This may be reported to the requestor so that the requestor may take steps to compensate. For example, the requestor may find another physician to contact if a failure to contact the physician is reported.

Asynchronous and synchronous communications may be deemed successful or unsuccessful in different ways due to their distinct characteristics. For example, a synchronous telephone call may be deemed unsuccessful if the physician does not answer the call, while an asynchronous text message may not be since the physician may take some time to read and respond to the text message.

In some embodiments, the physician's client device may present options for answering or responding to a contact request (e.g., a call, page, or text message). For example, if a call comes in, the physician may reject the call and provide an alternate method of communication, such as a page with callback number or text message. Likewise, if a text or page comes in the physician may respond and provide a phone number for voice communications, such as when an issue would be better discussed via a telephone conference.

If there was a failure to contact the physician, then the requestor may be notified of this failure at step 228. For instance, as discussed above, if a communication error occurs or the physician does not answer the phone the requestor may be so notified at step 228. It is noted that in some embodiments the requestor may be notified that contact failed after a period of time. This is to allow a physician a predefined period of time to read and respond. For example for pages or text messages the physician may be given a set period of time before the communication attempt is deemed unsuccessful and reported to the requestor as such. Different periods of time may be defined for different types of communications. For example, requests for asynchronous communication or urgent requests may have a shortened time period for a physician to respond before it is reported as a failure.

If contact fails or is unsuccessful, then the medical communication system may take a message at step 236. The message may be taken by the medical communication system itself or by forwarding or allowing a call to be forwarded to a voicemail or similar service. At a step 240, the medical communication system may receive a read receipt or other status notification regarding the message. For example, when the message is retrieved by a physician, such as via a client device, the client device may report this to the medical communication system. The medical communication system may in turn notify the requestor that the message has been received. This is beneficial in that the requestor receives feedback as to whether or not his or her message has been received, and make take further action based on this information rather than waiting around not knowing.

A message may also be forwarded in one or more embodiments. If a message is forwarded, the requestor may be provided a notification of this as well. This is beneficial because it allows a physician to send the message to an assistant or another physician who can handle the message and thus provide faster service to the requestor.

Messages may be presented to the physician via a client device. For example a list of message may be presented on a screen or display of a client device. This list may be sorted, such as based on urgency, requestor, time made or other criteria. Each message may be differentiated visually so that the physician may rapidly review the messages and decide in what order he or she will respond to the messages. In addition, the physician may see which of the messages have been responded to and which have not been.

It is noted that step 236 may not be performed when communication occurs via fax, text message, or the like since these communication methods would produce a message for later retrieval by a physician. In such cases, at step 240, the medical communication system may receive a notification that the message has been read or retrieved, such as described above. Also, like above, the medical communication system may report this information to the requestor.

Referring back to decision step 212, if the selected physician is not available, it may be determined if an alternate or substitute physician has been defined at a decision step 232. For example, a physician may specify, in his or her preferences, one or more other physicians that are in his or her practice group or that may cover for the physician. As shown in FIG. 2, the process may then return to decision step 212 where the availability of the substitute physician is determined.

If the substitute physician is available then, he or she may be contacted as disclosed above. If the substitute physician is not available, another substitute physician may be selected from the originally selected physician's preferences, if any and the process may continue as indicated in FIG. 2 and described above. If no substitute physicians are available (or no substitute physicians are defined) a message for the originally selected physician may be taken at step 236.

It is noted that the physician's preferences may indicate different substitute physicians or no substitute physicians for particular situations. For example, the physician may setup preferences such that requestors from a particular location may contact a first group of substitute physicians, while a second group of substitute physicians may be contacted for requestors at other locations. To illustrate, the first group may include physicians at a first clinic or hospital while the second group includes physicians at a second clinic or hospital. In this manner, a patient or medical professional at one clinic may be put into contact with physicians who work at the same clinic or location.

One benefit of the medical communication system is the ability to track communications with physicians and to make a record of such communication, such as for auditing, patient records, or the like. For instance, a nurse or other requestor would not need to make a note or record when a physician is contacted since the medical communication system may automatically track communication attempts made to physicians. In addition, the requestor need not note the subject matter discussed. This is because the medical communication system may record the messages that are sent through it to physicians. For example, the medical communication system may be setup to initiate a call between a requestor and a physician and record the call to make a record of it. The call may then be entered into a patient's records, if appropriate.

As can be seen, the medical communication system may be used in this manner to reduce or eliminate written notes in charts by nurses, paging operators or the like. In addition, this eliminates errors that may occur due to communication problems between requestors and physicians. The medical communication system may keep records of messages received and responded to, including the contents of text and voice messages, or video in visual messages. The time of the message and response thereto may also be tracked. This permits a timeline for responses to be established and is useful in verifying when contact was made with a physician and when a response was made by the physician. This is also useful in analyzing response times, establishing best practices, and identifying outliers for counseling such as physicians that do not respond to urgent messages. It is noted that the client device used by the requestor and the physician may be configured to allow a note (voice, text, video, or otherwise) to be attached to a message for inclusion into medical records. A notification may be sent to inform parties (e.g., the requestor or the physician) that a note has been made.

Another benefit of the medical communication system is the speed at which appropriate physicians may be found and contacted. Though described in multiple steps above, it is noted that from a user's perspective, the process of contacting a physician may be as easy as clicking on a physician or selecting a physician from a list. The medical communication system may automatically determine the best way to contact the selected physician (based on the physician's preferences, location, nature/urgency of the contact request, etc. . . . ) and proceed accordingly automatically.

In addition, the medical communication system collects up to date information regarding schedules, status, and contact information. This is because physicians may input updates to the medical communication system through a variety of mobile and non-mobile client devices. In this manner, the physician may change his or her status, update his or her schedule, and even change contact information from virtually anywhere and at any time. This is highly advantageous especially in unique situations. For example, if a physician loses or breaks his or her cell phone an alternate number may be quickly provided to the medical communication system. For instance, the physician may borrow a client device (e.g., a smart phone) or find a nearby client device (e.g., desktop computer) to update contact, status, or preference information at the medical communication system.

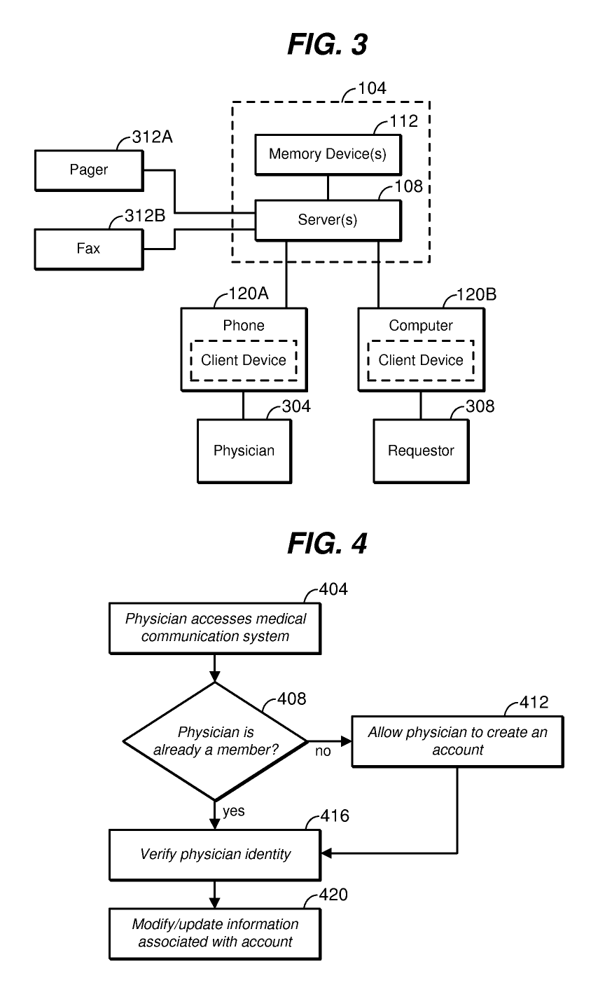

FIG. 3 is a block diagram illustrating communications between various devices when the medical communication system is in operation. As can be seen, the medical communication system 104 may communicate with various client devices 120 and various communications devices 312 when in operation. In the exemplary embodiment shown, the medical communication system 104 has communication links 116 with a smart phone 120A which functions also as a client device and a phone, and a client device in the form of a computer 120B. The medical communication system 104 also communicates with messaging devices, such as the fax machine 312B or pager 312A shown. It is noted that the medical communication system 104 may communicate with more than one of these devices. It is noted that a variety of communication links 116 may be used to effectuate communication. For example, a phone line (or the like) may be used to send faxes while a data link may be used to send text messages.

As shown in the example of FIG. 3, though a variety of client devices may be used, the physician 304 is using the smart phone 120A while the requestor 308 is using a computer 120B. In operation, the requestor 308 may select the physician via the computer 120B and as a result communication may be initiated with the physician 304, such as described above with regard to FIG. 2.

As can be seen, the medical communication system 104 may contact the physician 304 through its communication links with messaging devices or client devices. As discussed briefly above, the medical communication system 104 may function as a hub or intermediary through which communications may occur in some embodiments. For instance, if the physician preferences and availability indicate a phone call to the physician is in order, the medical communication system 104 may establish the call to the physician 304 and connect the requestor 308 to that call so that two-way communication may occur between the physician and requestor. The medical communication system 104 may, but need not, remain part of the call such as to record the conversation, forward the call to another physician or party, or to include additional physicians or parties in the call. It is noted that the physician's status may be updated to reflect that he or she is in a call in one or more embodiments.

If the physician preferences indicate contact should be made or initiated via pager or fax, then the medical communication system 104 may send a page or fax to a pager 312A or fax machine 312B specified by the physician, such as in the physician's contact preferences. The content of the page or fax may be obtained from the requestor via the client computer 120B, such as by sending a call back number or a document from the computer to the medical communication system 104. Alternatively, the medical communication system 104 may provide a fax in number or a paging number. The requestor may then fax or page this number with a fax machine, telephone, or other device. The fax or paging number may be a number that the medical communication system 104 provides. In this manner, communications by fax or page may be tracked and recorded automatically. The fax or page may then be forwarded by the medical communication system 104 to the physician's pager 312A or fax machine 312B. It is noted that in some embodiments, the fax or paging number may be that of the physician's pager 312A or fax machine 312B so direct communication may occur with these messaging devices.

The ability to function as a communications hub is also beneficial in that it permits delayed messaging. For example, a requestor may specify a delay time that must pass before a contact request or message (such as a text message for example) is sent to a physician. This is beneficial to avoid sending contact requests or messages at inconvenient times, such as the dead of night, which may not need to be sent at those times. In addition, since the requestor may input a delayed contact request or message in the medical communication system at any time, the likelihood the requestor will forget to pass along the request or message is greatly reduced, if not eliminated. A delayed contact request or message may be initiated by inputting a time or delay period with the request or message, such as at a client device used by a requestor.

It is noted that a physician may also specify delays in his or her contact preferences. For example, for incoming contact requests or messages of low urgency or of particular types, the physician may specify that they are delayed until he or she has a working status (e.g., is scheduled to work). Alternatively, these requests or other communications may be delayed until a reasonable time (or any other time desired by a physician), such as the next morning.

In one or more embodiments, the medical communication system may translate or convert one type of communications to another to allow the physician to more easily receive and read messages. For example, a message by fax may be converted to an image and sent to the physician's client device 102A, such as his or her smart phone. In this manner, the physician 304 does not have to go to a fax machine or pick up the fax to view its content, especially if the client device is a mobile device.

The same capability may work in reverse. For example, a physician 304 may fax documents such as prescriptions from his or her client device 102A. This allows physicians to issue prescriptions from virtually anywhere. It is contemplated that paper documents may be sent in this manner as well. For example, the client device 120A may be used to scan or photograph documents which may then be faxed to various numbers by first transmitting the scan or photograph to the medical communication system 104.

Some communication requests may request that a physician call a particular number. Physicians may be reluctant to do so with their personal phones since their caller id may give away their personal home or cell phone number. Rather than forcing physicians to carry multiple phones, the medical communication system 104 may use its communications hub capabilities to allow physicians to call requestors back without revealing their phone numbers. For example, a phone call from the physician may occur through the medical communication system 104 which may change or mask the physician's caller id such that a business phone or no phone number is shown. This may occur by the physician calling the medical communication system 104 and the medical communication system routing the call to the call back number. Alternatively, the physician may communicate two-way audio via a data connection with the medical communication system 104 and the medical communication system may patch in a call to the requestor with a selected caller id or no caller id.

FIG. 4 is a flow diagram illustrating an exemplary process through which the medical communication system may accept information to allow physicians to participate in (i.e., join and use) the system. As shown, at a step 404, a physician may access the medical communication system. As described above, this may occur by the physician accessing a server of the medical communication system via a client device.

At a decision step 408 it may be determined if the physician is currently a “member” (i.e., already has a valid account) of the medical communication system. If not, the physician may be prompted or required to create one before he or she may make further use of the system. At a step 412, the physician may create an account. Typically, this will involve the physician inputting identifying information, such as name, address, phone number, license information, or the like. Account creation may also collect billing information so that the physician may be charged for using the medical communication system. A picture of the physician may also be inputted. The physician may use various input devices (e.g., keyboard, mouse, touch screen, camera) of a client device to input this information. The client device may send this information to a medical communication system server where it may be stored for subsequent retrieval.

The account information may be stored separately from other information the physician inputs. In this manner, the physician may, but need not, define various contact preferences, contact numbers, and other contact methods that are separate or different from the account information. For example, personal numbers, addresses, and account numbers may be used to create an account and for billing purposes and contacting the physician with regard to the services offered by the medical communication system. Other contact information could then be used in the physician's preferences. The physician's private or personal information may be kept so in this manner.

Once the physician has an account, he or she may verify his or her identity with the medical communication system at a step 416. For example, the physician may verify his or her identity by logging in to the system with a username and password and/or other identifying information. It is contemplated that a physician may be permitted to input identifying information for other users, such as the physician's assistant(s), that may also access the physician's account, with various privileges.

At a step 420, the physician may setup or modify various aspects of his or her account. New information and modifications may be saved by a server and memory device of the medical communication system. For example, the physician may input one or more contact numbers, such as phone numbers, fax numbers, and pager numbers. The physician may also input one or more contact preferences. These may come in the form of rules. For example, call number X between time Y1 and Y2, but page number Z or take a message outside of that time. As can be seen, a variety of contact rules may be defined. The rules may also take into account the nature or urgency of a contact request. For example, call number X any time in life or death situations, emergencies, or for other urgent matters. Also, as discussed above, the rules may take into account a location, such as the requestor's location. For example, page number Z or take a message if requestor is requesting contact from clinic A, but call number X if requestor is at clinic B.

The contact preferences may include rules to contact other physicians. For example, if unavailable attempt contact with physicians 1, 2, and 3 (or any other number of physicians. It is noted that the physician may define different groups of physicians for use with the same or different rules.

The physician may also update or create a schedule by inputting his or her schedule information or updates into the medical communication system. For example, the physician may define a 5-day work schedule of various hours by inputting the same into the system. The physician may then create or adjust contact preference to take his or her schedule into account. For example, take a message if not scheduled to work, but call number X if scheduled to work or on call.

It is noted that the medical communication system may automatically update a physician's status based on the schedule if desired. For example, the physician's status may be changed to unavailable or on vacation or in surgery based on information indicating the same in his or her schedule. As stated, the physician may also update this information such as via his or her client device. For example, once logged in, the physician may manually set his or her status as appropriate. This would typically override the physician's current status.

In embodiments, where it is possible to receive a physician's location, it is contemplated that the physician may be permitted to activate or deactivate location tracking and save this information as part of his or her account information. In addition, the physician may define contact preferences based on his or her location (in addition or instead of the requestors location as discussed above). For example, call number X if I am at hospital 1, but page number Z if I am not.

The examples of contact preference rules above illustrate the versatility of the medical communication system. It is noted that the contact preferences may include a variety of rules having a variety of criteria. For example, time, status, physician location, request/requestor location, contact type, urgency, availability of substitute physicians, and other criteria could all be used in one rule, or a subset of these and other criteria may for a contact preference rule.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A medical communication system for communicating with one or more physicians comprising:
one or more servers comprising one or more communications devices, the one or more servers configured to:
present one or more physicians to a requestor through a first client device;
receive a contact request from a requestor through at least one of the one or more communications devices, the contact request comprising a physician identifier identifying a selected physician from the one or more physicians presented;
retrieve a status of the selected physician from one or more memory devices accessible to the one or more servers;
retrieve one or more contact preferences of the selected physician from the one or more memory devices using the physician identifier, the one or more contact preferences defining one or more rules for contacting the selected physician through one or more communications devices;
select at least one of the one or more rules based on at least the status of the selected physician; and
contact the selected physician by initiating communication with at least one of the one or more communication devices according to the at least one rule selected from the one or more rules.

2. The medical communication system of claim 1, wherein the one or more servers are configured to receive one or more status changes from the one or more physicians via one or more client devices, and to update a status of the one or more physicians with the one or more status updates.

3. The medical communication system of claim 1, wherein the one or more servers are configured to receive the location of the one or more physicians via one or more client devices carried by the one or more physicians, and to select the at least one rule based on the location of the one or more physicians.

4. The medical communication system of claim 1, wherein the one or more servers are configured to receive a work schedule from the one or more physicians, and to update the status of the one or more physicians based on the work schedule.

5. The medical communication system of claim 1, wherein each of the one or more rules defines a contact number and a criteria that must be met before the contact number may be used to initiate communication with a physician.

6. The medical communication system of claim 1, wherein the contact request includes a delay time and the one or more servers are configured to delay selection of the at least one rule and to delay contact with the selected physician according to the delay time.

7. The medical communication system of claim 1, wherein the one or more servers are configured to present the one or more physicians in an order based on a status of the one or more physicians, the status comprising an indicator of whether or not the physician is available for communication.

8. A medical communication system configured to facilitate communication with one or more physicians comprising:
one or more servers configured to:
receive status information from the one or more physicians and store the status information in one or more memory devices, the status information indicating the availability of the one or more physicians to respond to a contact request;
present the one or more physicians along with their status information to a requestor at a first client device;
receive a contact request from a requestor, the contact request comprising a physician identifier identifying a selected physician from the one or more physicians presented;
retrieve one or more contact preferences of the selected physician from the one or more memory devices using the physician identifier, the one or more contact preferences defining one or more rules for contacting the selected physician through one or more communications devices;
execute at least one of the one or more rules in response to the contact request; and
contact the selected physician by initiating communication with a communication device according to the at least one of the one or more rules.

9. The medical communication system of claim 8, wherein only physicians with status information indicating a current availability to respond to the contact request and which are present within a predefined area are presented at the first client device.

10. The medical communication system of claim 8, wherein the one or more servers are configured to receive one or more criteria for presenting the one or more physicians at the first client device, and to not present one or more physicians not meeting the one or more criteria at the first client device.

11. The medical communication system of claim 8, wherein executing a first of the one or more rules causes the one or more servers to initiate communication with a first communication device, and executing a second of the one or more rules causes the one or more servers to initiate communication with a second communication device, the first and second communication device being distinct.

12. The medical communication system of claim 11, wherein the first communication device is a pager and the second communication device is a phone.

13. The medical communication system of claim 8, wherein the one or more servers initiate communication with the communication device by calling the selected physician and subsequently connecting the requestor to the call.

14. The medical communication system of claim 8, wherein the contact request comprises an urgency indicator configured to identify the urgency of the contact request to the one or more servers.

15. A method for communicating with one or more physicians using a medical communication system comprising:
sending at least identifying information for one or more physicians to a client device for display at the client device;
receiving a contact request from a requestor, the contact request comprising a physician identifier identifying a selected physician from the one or more physicians;
retrieving one or more contact preferences of the selected physician from one or more memory devices using the physician identifier, the one or more contact preferences defining one or more rules for contacting the selected physician through one or more communications devices;
selecting at least one of the one or more rules based on at least a status of the selected physician, wherein the status indicates the availability of the selected physician to respond to the contact request; and
initiating communication with at least one of the one or more communication devices according to the at least one rule selected from the one or more rules.

16. The method of claim 15 further comprising receiving a location of the selected physician, wherein the at least one of the one or more rules is selected based on the status of the selected physician and the location of the selected physician.

17. The method of claim 15 further comprising receiving an urgency indicator along with the contact request, wherein the at least one of the one or more rules is selected based on the status of the selected physician and the urgency of the contact request as identified by the urgency indicator.

18. The method of claim 15 further comprising receiving the one or more contact preferences defining the one or more rules for contacting the selected physician from a client device of the selected physician.

19. The method of claim 15 further comprising receiving a delay time from the requestor, wherein initiating communication with the at least one of the one or more communications devices is delayed according to the delay time.

20. The method of claim 15 further comprising receiving one or more substitute physician identifiers from the selected physician, the one or more substitute physician identifiers identifying one or more substitute physicians with which communication may be initiated.

21. The method of claim 15 wherein a schedule of the selected physician is displayed to the requestor.
